(19) United States
(12) Patent Application Publication
(10) Pub. No.: US 2015/0369447 A1
(43) Pub. Date: Dec. 24, 2015

(54) LIGHTING ARRANGEMENT AND METHOD FOR PRODUCING AN LIGHTING ARRANGEMENT

(71) Applicant: OSRAM GMBH, Munich (DE)

(72) Inventors: Bakuri Lanchava, Regensburg (DE); Simon Schwalenberg, Donaustauf (DE); Julius Muschaweck, Gauting (DE)

(21) Appl. No.: 14/765,574

(22) PCT Filed: Jan. 30, 2014
(86) PCT No.: PCT/EP2014/051836

§ 371 Date: Aug. 4, 2015

(30) Foreign Application Priority Data
Feb. 4, 2013 (DE) 10 2013 201 772.3

(51) Int. Cl. F21V 5/00; F21V 8/00; G06F 17/50; F21S 8/04

(52) U.S. Cl. CPC F21V 5/004; F21S 8/04; G02B 6/0006; G06F 17/50

(57) ABSTRACT

Various embodiments may relate to a lighting arrangement and a method for producing or for operating the same. The lighting arrangement includes a plurality of radiating faces, on which light may be emitted in each case as a beam. Owing to this “direction competence”, the lighting arrangement may not only reproduce a two-dimensional image of an illumination pattern, but it may emit light directionally and thus reproduce a luminance distribution of the illumination pattern.

### RELATED APPLICATIONS

The present application is a national stage entry according to 35 U.S.C. §371 of PCT application No.: PCT/EP2014/051836 filed on Jan. 30, 2014, which claims priority from German application No.: 10 2013 201 772.3 filed on Feb. 4, 2013, and is incorporated herein by reference in its entirety.

### TECHNICAL FIELD

Various embodiments generally relate to a lighting arrangement and to a method for producing a lighting arrangement.

### BACKGROUND

The related art discloses not only conventional wall and ceiling luminaires including emitters but also lighting arrangements which emit light over a large area, for instance for illuminating an exhibition space. For this purpose, the illuminants can be arranged for example behind a translucent sheet or behind a cloth, which results in a uniform light emission.

### SUMMARY

According to various embodiments, a lighting arrangement for spatially reproducing a lighting motif and a method for producing are provided.

In an abstract consideration, the illumination in the manner according to various embodiments is subdivided into two steps, namely
the detection of the lighting motif and
the subsequent reproduction, that is to say the lighting.

To put it in a simplified way, the first step involves detecting the three-dimensionality of the lighting motif, that is to say determining the light emitted thereby in different directions, for example also by rendering. The second step, the reproduction giving an impression of three-dimensionality, then correspondingly presupposes a lighting arrangement which can emit light in a targeted manner location- and direction-dependently, as “beams” (which, in the context of this disclosure, is also referred to as “direction competence” of the lighting arrangement).

A lighting arrangement having “direction competence” is distinguished by the fact that light can be emitted at a multiplicity of emission surfaces, specifically per emission surface as a beam having a selected direction or as a multiplicity of beams in freely selectable directions and with individually predefined luminous fluxes. For this purpose, the lighting arrangement can be constructed from a multiplicity of optical fibers, for example, into the entrance surfaces of which the light emitted by a light source is coupled in each case.

The exit surfaces of the optical fibers are then mounted for example on a ceiling, for instance in a manner always combined bundle by bundle to form repeating subunits (lighting units). In this case, the exit surfaces of the optical fibers of a lighting unit can lie in a manner arranged alongside one another as emission surfaces for example on a spherical shell, such that the lighting unit emits a bundle of divergent beams. For its part, the lighting arrangement can be constructed from a multiplicity of such lighting units, for instance form spherical shells mounted alongside one another on a ceiling (having in each case a multiplicity of emission surfaces).

In this example, an emission direction and an emission surface are defined per optical fiber; provided that no imaging optical unit is disposed downstream of the exit surface of an optical fiber, the exit surface is identical to the emission surface. Generally, “emission surface” means the last exit surface for the beam facing the observer/an observation position. Emission surface and emission direction jointly constitute a “pixel”, which is also explained in detail below and to which the desired luminous flux is then assigned, for example by corresponding control of the light source.

In this case, the luminous flux of the individual pixels is intended to be set such that the light emitted by the individual emission surfaces in each case along a beam gives the impression of not coming from the lighting arrangement, but rather from “behind that”. An observer standing for example only a few meters, for instance at least 3 m, 5 m, 7 m, 10 m, 15 m or 20 m, but for example not more than 50 m, 40 m, 30 m, away from the lighting arrangement is intended for example to have the impression of looking into the dome of St. Peter's Basilica with a height of more than 100 m.

The lighting motif can be for example a light reflecting or emitting, three-dimensional arrangement, for example a segment of a real building; that is to say for instance a ceiling; the three-dimensionality can be governed for example by a curvature of the ceiling, for example by a dome shape. Generally, the three-dimensionality of the lighting motif can be governed by the arrangement of individual elements thereof at different distances from an observation point.

Besides the possibility of reproducing a lighting motif that really exists, the three-dimensional arrangement can also be generated virtually by, for instance, a CAD program being used to create individual elements thereof and put them into a spatial arrangement with respect to one another.

The present disclosure is based on the following insight: for the three-dimensional optical impression that an observer has of the dome of St. Peter's Basilica for example when striding through St. Peter's Basilica, what is ultimately crucial is from what direction or what directions how much light of what color comes to the individual observation positions passed in the course of striding through.

For illustration and also for modeling purposes, the lighting motif can in this case be subdivided into a multiplicity of surface elements and per surface element the light propagating therefrom in different directions can be modeled with a multiplicity of light beams, the starting point of which in each case lies on the surface element.

The lighting motif, in particular a side thereof that faces the observation positions, is therefore subdivided for example into disjoint surface elements and the luminous flux emitted direction-dependently is determined for each of these surface elements. The “subdivision into surface elements” can for example also consist in the fact that a (real or virtual) lighting motif is “scanned”, that is to say that the luminous flux emitted from different regions (emission surfaces) thereof is determined (in each case in a directionally resolved manner); the lighting motif need not necessarily be subdivided into surface elements before the luminous flux determination, rather the subdivision can also be carried out in the course thereof, for instance if the luminous flux is determined in a manner distributed statistically over the surface of the lighting motif. (In the case of a luminance measurement described below, the subdivision into surface elements can be governed for instance by the resolution during the measurement.)

In any case the luminous flux emitted along a multiplicity of straight lines from the lighting motif, that is to say the respective surface element (pervaded by the respective straight line or straight lines) of said lighting motif is determined; the straight lines tilted with respect to one another connect different regions of the lighting motif (surface elements) to different regions of the reference surfaces (reference surface points).

The dome is illuminated indirectly, for example, and reflects the light partly in the direction of the observation positions situated below the dome, wherein the reflection properties can lie between two extremes depending on the surface constitution, namely between ideally diffuse and ideally specular.

To put it in a simplified way, an incident light beam is usually not just ideally reflected (although this is also possible for instance in the case of a mirror), but rather additionally expanded to a certain extent to form a beam bundle (see FIG. 3). A surface element of the lighting motif emits different amounts of light in different directions (along different straight lines intersecting in the surface element), that is to say “appears” differently bright and/or colored when viewed from different directions (see FIGS. 2A and 2B).

In the idealized consideration with light beams (“beam model”, also see FIGS. 2A and 2B), therefore, a multiplicity of light beams having different luminous fluxes propagate from each surface element, which can be illustrated by way of a corresponding length of the light beams, and an observer looking at a specific surface element “sees” different light beams and accordingly also a different luminous flux depending on the observation position of said observer. This can also be described by way of the luminance, which indicates what luminous flux is emitted by a given point of the lighting motif per projected area element and per solid angle element (and, if one wishes also to draw a distinction in terms of color besides brightness, per wavelength range) (luminous flux per etendue subvolume, in this respect see the following description).

Various embodiments provide a lighting arrangement such that the light emitted at one of its emission surfaces along a beam corresponds to the light emitted by one of the area elements of the lighting motif along a straight line on which precisely said beam lies (in any case with regard to brightness, optionally also in terms of color); for reproducing the lighting motif, this is then intended to come true for all emission surfaces with their beams.

In other words, the lighting arrangement emits light with a multiplicity of beams, for instance—with increasing preference in this order—at least 10 000, 160 000 or 2 560 000 beams, specifically in each case light such as is emitted or was emitted along a straight line on which the respective beam lies from the lighting motif.

An observer who strides through St. Peter's Basilica, for example, and in the process allows his/her gaze to wander over the dome thereof actually perceives the latter three-dimensionally on account of the light emitted differently in a direction-dependent manner from the individual surface elements (the same also holds true given a fixed observation viewpoint, in principle, owing to the interocular distance); by contrast, if the observer takes a photograph of the dome, the three-dimensional impression is lost because the light emitted from each surface element is precisely not detected in a directionally resolved manner, but rather in each case only from one direction.

For illuminating for example a floor surface with the lighting motif “dome”, for instance, firstly the mounting position of the lighting arrangement and thus the position of the emission surfaces are defined; the emission surfaces can be mounted for example on a ceiling horizontally in a planar manner alongside one another. This lighting arrangement is then “conceived” with the emission surfaces in St. Peter's Basilica, wherein the floor surface to be illuminated is situated in a plane with the floor below the dome of St. Peter's Basilica; the lighting arrangement is thus situated between floor and dome.

For each emission surface, the luminous flux emitted along a straight line, on which the beam of the respective emission surface lies, from the lighting motif, that is to say precisely the dome, for example, is then determined (according to brightness and optionally color). If each emission surface then emits its beam with the luminous flux thus determined, an observer (in an idealized view) cannot distinguish whether he/she is standing under the lighting arrangement or for example actually under the dome of St. Peter's Basilica. (The statements made above and also below are intended to be disclosed, of course, independently of the lighting motif “dome” and the illumination of a floor by a horizontally arranged lighting arrangement.)

The “reference surface”, that is to say the mounting position of the lighting arrangement “conceived” in St. Peter's Basilica in the above example, is as it were an interface between the lighting motif (the light emitted by the latter direction-dependently) and the lighting arrangement (the light to be emitted by the latter direction-dependently). Accordingly, the direction-dependently incident (“incident” in the case of a reference surface situated between the observation positions and the lighting motif) luminous flux in the reference surface is determined and the emission surfaces lie in the same surface.

In the above example, the lighting arrangement was then set up such that an observer of the lighting unit has the same impression as an observer of the dome in reality, specifically on account of the floor surfaces at the same level, that is to say observer viewpoints. However, if the lighting arrangement were mounted higher, above the mounting position for which the luminous flux was determined direction-dependently, the dome would appear further away, as if St. Peter's Basilica were not being observed from its floor, but rather from a deeper space incorporated into the floor.

The position of the reference surface relative to the lighting motif can be chosen freely, in principle; it influences (only) the representable solid angle. The reference surface can even also be placed behind the lighting motif, that is to say that, for instance, for emission surfaces situated above the dome of St. Peter's Basilica it is possible to determine how much light is to be emitted per beam in order that it corresponds to the light emitted from the dome along the respective straight line on which the corresponding beam lies.

The lighting arrangement can emit light as a beam having a specific luminous flux at an emission surface, that is to say in a specific emission direction, wherein the luminous flux of the emission points can in each case be set individually; preferably, the luminous flux emitted with the individual beams is also controllable during operation (with regard to brightness and preferably also color), particularly preferably by a common control unit.

The lighting arrangement can therefore emit in each case different amounts of light (optionally of different colors) with a multiplicity of beams tilted with respect to one another, that is to say has a “direction competence”, such that different views of the lighting motif are reproduced.

The beams are tilted with respect to one another and thus fill the emission solid angle to be covered overall; nevertheless, beams parallel to one another are also present, however. By way of example, each lighting unit provides a set of beams tilted with respect to one another, but said set is repeated with the number of repetitions corresponding to the number of lighting units in the lighting arrangement.

The “straight line” is a straight line in three-dimensional space which is defined in terms of its position and in this respect differs from a “direction” (a vector that is still displaceable). The “beam” of an emission surface is a half-line defined in terms of its direction (“emission direction”) and position; the position of the half-line is defined by the emission surface. The “emission direction” is generally an average value of directions weighted according to the luminous flux (for instance also on account of diffraction and/or scattering effects); the aperture angle of the light emitted at an emission surface is, for example, with increasing preference in this order, less than 10°, 5°, 2°, 1°. An emission surface can have for example a lateral extent of—with increasing preference in this order—at most 160 mm, 80 mm, 40 mm, 20 mm and 10 mm; minimum sizes can be for example 2.5 mm, 4 mm or 5 mm (measured as diameter of the a circular shape or, in the case of a geometry having an irregular exterior shape, as average value of the smallest and largest extents).

The luminous flux emitted (as a beam) by an emission surface in a specific emission direction is intended to “correspond” to the light emitted from the lighting motif in the same direction, which is also intended to encompass a deviation by a predefined percentage; the luminous flux of other emission surfaces then deviates by the same percentage (this can hold true, for instance, for at least 25%, with increasing preference in this order at least 50%, 70%, 80%, 90%, of the emission surfaces).

A brightness adaptation is possible. Preferably, the brightness of the lighting arrangement is even dimmable, for instance by a control unit, particularly preferably down to a switched-off state, specifically—with further preference—in a continuously variable manner.

In various embodiments, raw data are generated by the three-dimensional lighting motif and the luminous flux is determined per reference surface point by said raw data being rendered, that is to say by an image synthesis. Corresponding image synthesis programs (renderers) are commercially available, for example under the trade name “Radiance”.

In general, however, it is also possible to determine “analogously”, that is to say without image calculation, what luminous flux is to be emitted per reference surface point, namely if directionally resolved images are generated from a real lighting motif in the reference surface and the respective recordings are then reproduced in a directionally resolved manner toward an observation position (in this respect, cf. in detail the exemplary embodiment in FIGS. 1A and 1B).

However, firstly raw data of the lighting motif are generated; in the case of a virtual lighting motif, therefore, for instance, the relative arrangement of individual elements and/or a surface profile of the lighting motif are/is defined; the raw data can for example also include the optical properties of a surface, for example the reflection properties, and the arrangement and beam direction of a light source. Subsequent rendering then involves determining by ray tracing, for example, the luminous flux which is emitted in each case along a straight line passing through a reference surface point (and which is accordingly to be emitted at said reference surface point by the lighting arrangement with a beam lying on the straight line).

However, raw data can also be generated from a real lighting motif, specifically preferably by a luminance measurement; the latter is carried out particularly preferably in a wavelength-resolved manner, such that the raw data also contain color information. During a luminance measurement, the light emerging from a surface element of the lighting motif is not detected by averaging, which would correspond to a conventional photograph, rather the luminous flux is measured in a directionally resolved manner.

Specifically, the luminance is the luminous flux per etendue subvolume (dE); the etendue is defined as the product of area element and projected solid angle, cf. for example R. Winston, “Nonimaging Optics”; the luminance is the luminous flux per “light subvolume”, that is to say characterizes the distribution of the luminous flux in this “light volume” (in a four-dimensional phase space, cf. the mathematical definition of etendue), in a manner similar to how mass density, for example, describes the mass distribution in a three-dimensional body.

The luminance can be measured for example by a camera, for instance a CCD camera, which is moved along a surface, for example, and makes recordings of the lighting motif at different points, usually following a grid. With knowledge of the optical system of the camera, a direction (angle resolution) can then be assigned to a specific pixel of the CCD array (spatial resolution), that is to say it is possible to determine from what direction the light was incident.

With a multiplicity of such camera images and with knowledge of the respective recording position, it is then possible to determine the luminance of the lighting motif, that is to say the luminous flux emitted from a surface element in different directions.

In this case, the camera is usually not focused onto the surface of the lighting motif, but rather onto a reference surface spaced apart therefrom; by rendering, it is then possible to determine therefrom the luminance for other reference surfaces. Such luminance measurements are known in principle from the characterization of substantially point light sources, for example an incandescent bulb, the camera being moved in a goniometer around the light source, cf. “Analysis of Goniophotometric Reflection Curves”, Isadore Nimeroff, Journal of Research of the National Bureau of Standards, Vol. 48, No. 6; June 1952, p. 441-448.

At any rate, information regarding the direction-dependently emitted light is then present in each case with the data obtained from the luminance measurement for the surface elements of the lighting motif. For a surface element of the lighting motif, luminous flux values (“taken along a multiplicity of straight lines”) are thus present for a multiplicity of directions.

If the reference surface is displaced, for example, light previously emitted by a first emission surface in a first emission direction can then be emitted by a second emission surface, which is displaced relative to the first emission surface laterally (perpendicularly to the direction determining the distance to the lighting motif), in the same emission direction (cf. FIGS. 2A and 2B). In the new reference plane, however, there is not necessarily an emission surface whose beam lies with that of the first emission surface on a straight line, such that, for instance, the luminous flux emitted from the surface element of the lighting motif along a different, closely “adjacent” straight line can be reproduced.

Intermediate values lying between the measured luminance values with regard to the solid angles can generally be determined by rendering in this case, specifically concerning the angular resolution and/or the area resolution of the luminance measurement.

“Raw data” generally means, therefore, a data set which contains luminance information and/or from which such information can be determined. In the case of a virtual lighting motif, the luminance information can be determined for example from the arrangement of a surface, its constitution and the position of a light source, for example by ray tracing; however, the raw data can also be measured luminance values and intermediate values can be determined by rendering, in the manner similar to an interpolation.

In a set of raw data, the information concerning the luminance in this case need not necessarily already be stored as luminance values; for example, a pair of numbers, for instance including luminous flux and etendue, can also always contain corresponding information; what is crucial, rather, is that the luminance can be calculated therefrom.

In the context of the present disclosure, reference is made to the photometric variable “luminous flux” and correspondingly to “light intensity, illuminance and luminance”, that is to say in each case to the photometric counterpart with respect to the radiation-physical variables “radiation power, radiant intensity, irradiance and radiance”. The luminous flux corresponds to a radiation power weighted with the wavelength-dependent sensitivity of the human eye (V(λ) curve); the statements made in the context of this disclosure in respect of the photometric variables analogously apply to the radiation-physical variables.

In one consideration, the provision of emission surfaces having a specific size at a specific distance from one another can be considered to be the predefinition of a discretization; the lighting arrangement has a corresponding spatial resolution and, depending on the tilting of the emission directions/beams, also solid angle resolution. Each emission surface together with the emission direction of its beam can be considered to be a “pixel”, namely “pixel” that predefines an etendue subvolume (the etendue subvolumes of the emission surfaces in summation yield the etendue of the lighting arrangement).

Rendering is carried out to determine the luminous flux which is to be assigned to an etendue subvolume in order that together with the other pixels (etendue subvolumes likewise “filled” with luminous flux) a luminance profile arises such as would be emitted by the lighting motif. By rendering, discrete values for “filling” the etendue subvolumes are determined, for example by interpolation from discrete luminance values and/or else by local averaging from a continuous/quasi-continuous data field.

This can be illustrated on the basis of the two-dimensional example of raster graphics: an image of a motif (analog of the lighting motif) is recorded, and a raster determined by the pixel size in terms of line and column spacing is placed over the image and an average brightness value is determined for each raster cell (gray scale raster graphics).

A “pixel” is therefore characterized by an emission surface and an emission direction (the direction of the corresponding beam); the etendue subvolume thus defined can then be filled for example with white light and/or else with colored light;

depending on the emission surface, therefore, for example a plurality of light sources of different colors can also be provided, that is to say that the etendue subvolume can for example also be filled by a color mixing.

In a preferred configuration, in this case firstly the arrangement of the emission surfaces is defined, that is to say that firstly the discretization is performed; the “raster pitch” is determined. Afterward, rendering is carried out with regard to the discretization predefined in this way. For instance, pixels with a respective etendue subvolume are predefined and the luminous flux respectively required for “filling” is determined by rendering. In general, on the other hand, the arrangement of the pixels and the “size” thereof (that is to say the respective etendue subvolume thereof) could specifically also be adapted to previously measured and/or previously rendered data.

The “direction competence” therefore relates to the suitability of the lighting arrangement for emitting light at a multiplicity of emission surfaces, specifically per emission surface in a selected direction and with preferably a luminous flux that is predefinable by a control unit; a lighting arrangement has “direction competence” in this respect if it provides “pixels”, that is to say etendue subvolumes, and means, that is to say light sources, with which the etendue subvolumes can be individually “filled”.

Generally, the lighting arrangement will extend over a large area, also to enable an observer to have a “gaze wandering thereover”, for example, in order thus to allow a convincing three-dimensional impression to arise. “Large area” means for example with a light-emitting surface area of—with increasing preference in this order—at least 10 m², 20 m², 30 m², 40 m², 50 m², 60 m², 70 m², 80 m², 90 m², 100 m²; upper limits independent of this lower limit can be for example 1000 m², 900 m², 800 m², 700 m², 600 m², or 500 m².

In this case, the area can have an arbitrary shape, in principle; the ratio of largest to smallest extent in the area direction can be for example at least 1:1, 3:2, 2:1, 3:1 and, independently of this lower limit, can be for instance at most 100:1, 50:1, 20:1, 10:1.

The lighting arrangement according to various embodiments is intended to allow the three-dimensional impression to arise not just with regard to a single observed region (“viewpoint”). Rather, the observer is intended to be able to allow his/her gaze to wander over the lighting arrangement at an observation position, that is to say that an observation angle of at least 20°, 60° or 90° is intended to be accessible for example depending on the observation position; with regard to the fineness of the discretization, more than 5, 20 or 40 different viewing directions can then be possible for example depending on the observation position. The three-dimensional impression could be established for example even assuming observation with only one eye, since the different views seen by an observer moving along the lighting arrangement through different observation positions would then be “combined” in said observer's perception.

In this context, too, a lighting arrangement is preferred which reproduces the spatial views not only in relation to a first observation line but also with regard to a second observation line extending transversely (at an angle) with respect to the first observation line. “Observation line” means a line which connects a multiplicity of observation positions from which the lighting motif can be observed from different viewing directions in each case.

In the case of a lighting arrangement installed for example several meters above the floor on a ceiling or as a ceiling (both will be referred to hereinafter as “ceiling mounting” for the sake of simplicity), a first observation line then extends along the floor and at least one further observation line extends transversely with respect thereto, likewise along the floor. Ideally, in the case of generally preferred ceiling mounting, there are a multiplicity of observation positions distributed areally over the floor opposite the lighting arrangement, for instance—with increasing preference in this order—at least 10, 20 or 40 and, independently of this lower limit, with increasing preference in this order, for example, at most 200, 100 or 50 observation positions adjacent to one another in the area direction.

Perpendicular to the floor there can for example also be a plurality of adjacent observation positions; the latter can span an “observation window”, for instance, which is for example a little distance away from the floor, for example between 1 m and 2 m; in the case of a lighting arrangement designed (also) for seated or recumbent observation, however, the observation positions can also be situated at a lower level, for instance also extend to the floor. An “observation position” is a position which is defined in its relative position with respect to the lighting arrangement and to which light passes from a multiplicity of emission surfaces in a multiplicity of emission directions (in other words, a multiplicity of beams meet), for example relative to an “observation volume” per observation position of (0.25 m·0.25 m·0.25 m), (0.5 m·0.5 m·0.5 m) or (1 m·1 m·1 m).

At any rate, in a preferred configuration, there are a plurality of observation lines oriented transversely with respect to one another, that is to say that the beams are tilted for example relative to a normal to the lighting arrangement not just in one direction (all planes spanned by the surface normal with a respective beam would then be parallel), but rather in two directions, such that the planes respectively spanned by surface normal and beam are not only displaced parallel but also rotated with respect to one another.

In various embodiments, a minimum amount is predefined for the size of the reproduced motif as a ratio relative to the size of the lighting motif, that is to say that this size ratio—with increasing preference in this order—is at least 1:4, 1:3, 1:2; particularly preferably, the lighting motif is reproduced with substantially the same size in any case. These indications relate of course (primarily) to the case of real lighting motifs (also the case of a virtual lighting motif which simulates a real lighting motif).

If a “magnification” is also possible, that is to say that the ratio of reproduced motif to lighting motif can also be greater than 1:1; exemplary upper limits are 1 000 000:1, 100 000:1, 10 000:1, 1 000:1, 100:1, 10:1. If the lighting motif has a different size from different viewing directions, these (and the above) indications relate to a perpendicular projection onto the reference surface, that is to say beams perpendicular to the lighting arrangement (if appropriate beams perpendicular to a mounting plane).

The reproduced lighting motif is preferably motionless in an area proportion of at least 50%, with increasing preference in this order, at least 60%, 70%, 80%, 90%, specifically in any case with regard to the perpendicular projection onto the reference surface as just mentioned, particularly preferably with regard to all views (with regard to all viewing directions).

“Motionless” means that in any case the ratio of the luminous flux emitted by the individual emission surfaces is maintained (uniform dimming is therefore not motion), specifically for, by way of example, at least 10 seconds, 30 seconds, 1 minute, 5 minutes, 30 minutes, 1 hour, 3 hours. Ultimately, this can also be coordinated with the specific lighting purpose, such that rather static illumination is effected for instance in a work environment, whereas the dynamic proportion can be grater in the case of a presentation or stage production, for example.

Furthermore, an alteration of the lighting that is coordinated with an observer may also be preferred; for this purpose, a movement of the observer with the observer's position being unchanged, for example an arm movement, and/or the observer's position (a change thereof) relative to the lighting arrangement are/is preferably detected by a sensor and the lighting motif is reproduced in a manner dependent thereon. Coming back to the example of the dome, therefore, for example the position of the sun shining through the window could shift with the observer if the latter strides through the area. However, the observer could also shift the sun with an arm movement, for example.

An observer is therefore detected by a sensor, for example, for instance optically and/or acoustically; this sensor signal is then evaluated in an evaluation unit and converted into a control signal for the lighting arrangement. In a preferred configuration, a control unit is also part of the lighting arrangement, to be precise generally, that is to say also independently of the detection of an observer by a sensor. The “coordination with the observer” is preferably effected by corresponding driving of the lighting arrangement.

Therefore, an observer can now control the lighting arrangement by gestures and/or sounds; by way of example,
turning the hand upward and bringing the fingers together can reduce the brightness, for instance of the entire lighting arrangement (globally) or else only at the observer's standpoint (locally);
opening the fingers (equally with the hand facing upward) can mean increasing the brightness, once again globally or locally;
by generating sounds at a specific location, the brightness can be increased there, such that by scratching or drumming with the fingers on a surface, for instance, the brightness on said surface is increased—it can be reduced again by clapping, for example.

An alteration of the reproduction, that is to say an alteration of the luminous flux emitted by the individual emission surfaces, generally is ideally not carried out abruptly, but rather at least in stages, particularly preferably smoothly, that is to say in a continuously variable manner.

In all generality, “alteration coordinated with an observer” is for example also regarded as driving of the lighting arrangement which follows a circadian rhythm, that is to say, for example, reproduces a day/night progression with a period length of 24 hours in a manner approximately corresponding to the internal rhythm of an observer.

With regard to an observer's physiological sensitivity, too, the profile of the reproduced electromagnetic spectrum preferably at least in the visible range corresponds to the solar spectrum, that is to say that the relative luminous fluxes, in each case normalized to a maximum value, of sunlight and lighting arrangement deviate from one another for example by at most 50%, 60%, 70% or 80%, specifically in a range of at least 50%, 60%, 70%, 80% or 90% of the visible spectral range. By way of example, an RGB or RGBW lighting system is appropriate as light source.

In this context, one advantage of the lighting arrangement according to various embodiments may consist in the fact that, since the lighting arrangement itself is luminous, a blue light component sufficient for the physiological sensitivity of an observer can be emitted, without for example the entire lighting arrangement appearing blue for this reason; this last would namely be the case, under certain circumstances, if a comparable blue light component is intended to be achieved with indirect lighting of a ceiling.

In various embodiments, the lighting arrangement includes an imaging optical unit, that is to say that the emission surface is situated on an exit surface of the imaging optical unit; preferably, per pixel a light emitting surface is imaged into the space, to be precise particularly preferably into infinity.

In the case also of the example—already mentioned in the introduction—of a lighting arrangement constructed modularly from a multiplicity of optical fiber bundles (modular construction, a bundle is a lighting unit), such an imaging optical unit can be provided, specifically for example per optical fiber a dedicated lens that concentrates the emerging light. The imaging optical unit would therefore serve for collimating the light emerging from the respective optical fiber.

In general, such a “collimation” could nevertheless also be implemented without an imaging optical unit, for instance with a collimated input coupling or, on the output coupling side, with a non-imaging optical unit; in the case of the optical fiber, for instance, the diameter thereof can be embodied in a manner widened toward the exit surface, such that the beam cross section is therefore enlarged and, on account of the conservation of etendue in an optical system, the aperture angle of the beam is thus correspondingly reduced (the etendue is a conservation variable, that is to say that a light beam cannot become arbitrarily small simultaneously in terms of diameter and solid angle, rather a reduction of the beam cross section leads to beam expansion, and vice versa).

Preferably, in any case, the lighting arrangement includes an imaging optical unit, wherein particularly preferably a plurality of light emitting surfaces are arranged alongside one another and are imaged by a common imaging optical unit. The emission surfaces then lie on the opposite sides of the imaging optical unit relative to the light emitting surfaces.

The imaging optical unit can be for example a spherical lens or else a lens system including such a lens, or else a so-called Fresnel lens. The light emitting surfaces are “arranged alongside one another”, that is to say lie in a common, preferably planar, surface.

If a converging lens is then provided as the imaging optical unit and if the light emitting surfaces are arranged in the focal plane of said lens, for example, the different spatial points (light emitting surfaces) are imaged in different directions. The distribution of the light emitting surfaces in the space domain becomes a distribution in different angles (emission directions), and the spatial function becomes a solid angle function by Fourier transformation.

A spherical lens as the imaging optical unit is preferred insofar as in the case of a multiplicity of light emitting surfaces arranged alongside one another in a planar fashion in relation to two directions, the beams are then also correspondingly tilted with respect to one another not only with regard to a first direction, but also with regard to a second direction (cf. the explanations above concerning the two “observation lines”).

The light emitting surfaces arranged alongside one another and assigned to a common optical unit, together with the imaging optical unit, constitute a lighting unit that provides a multiplicity of “pixels”.

Generally, a lighting arrangement according to various embodiment may be constructed modularly, that is to say assembled from a multiplicity of structurally identical lighting units, for example from at least 1·10³, 1·10⁴, 1·10⁵, 1·10⁶, 1·10⁷, 1·10⁸ lighting units; possible upper limits for the number of lighting units are, for example, 1·10¹², 1·10¹¹, 1·10¹⁰ or 1·10⁹.

A lighting unit can have for example a lateral extent of at least 0.1 cm, 0.5 cm or 1 cm; with regard to an upper limit, at most 50 cm, 10 cm or 5 cm is preferred (measured as the diameter of a circular shape or, in the case of a geometry having an irregular exterior shape, as an average value of the smallest and largest extents). A limitation of the maximum extent of the lighting units is preferred with regard to a spatial resolution of the lighting arrangement.

The lateral extent of an imaging optical unit, in particular of a converging lens, that is to say its diameter or the average value of smallest and largest extents, can be for example at least 0.1 cm, 0.5 cm or 1 cm; possible upper limits are, for example, 50 cm, 10 cm or 5 cm.

The distance between two closest adjacent lighting units can be, for example, at least 0.1 mm, 1 mm or 5 mm; specifically, a certain minimum distance can facilitate assembly, for example, or damage to the closest adjacent lighting units can be prevented upon replacement of individual lighting units. Preferably, the maximum distance between two closest adjacent lighting units does not become greater than 50 cm, 10 cm or 5 cm, which is advantageous with regard to the spatial resolution.

In a further embodiment, which for instance can also be of interest with regard to an optimization of the spatial resolution, the imaging optical unit of a lighting unit additionally has a microlens array, which is preferably provided between a main lens/a main lens system of the lighting unit and the light emitting surfaces thereof. If the multiplicity of light emitting surfaces of the lighting unit were imaged beforehand, that is to say for example by a common converging lens, the microlens array is then interposed, that is to say that a set of light emitting surfaces, that is to say a subset, is in each case imaged by a common microlens and the microlenses are imaged by the common converging lens.

As a result, although the angular resolution of the lighting unit decreases, its spatial resolution is correspondingly improved; the lighting unit is once again subdivided into a number of subunits corresponding to the number of microlenses.

In the case of a “lighting unit” in which the light emitting surfaces are assigned to a common, preferably imaging optical unit, in the case of a plurality of successive, imaging optical units (microlens array and “macrolens”), the optical unit for the assignment to a lighting unit which combines more light emitting surfaces is crucial; the microlens array is imaged by a “larger” lens, that is to say does not provide dedicated lighting units. This also accords with the understanding of “lighting units” as units that can be combined modularly to form a lighting arrangement, since the microlens array is usually already embodied in an integrally continuous fashion and in this respect not in a modularly combinable fashion.

A rotationally symmetrical microlens array is also preferred with regard to the tilting of the beams with respect to one another in relation to two directions (observation lines lying transversely with respect to one another). The lateral extent of a microlens (its diameter or the average value of smallest and largest extents) can be for example at least 0.5 mm, 1 mm or 2 mm; possible upper limits are, for example 16 mm, 8 mm or 4 mm.

Preferably, the light emitting surfaces are arranged in a focal plane of the microlens array that faces away from an observer;

the microlens array particularly preferably lies in a focal plane of the imaging optical unit, that is to say for example in the focal plane of a converging lens.

In various embodiments, the generation of light is carried out with a phosphor element which emits converted light having a longer wavelength in a manner excited by pump light. “Pump light” should be understood very generally, that is to say is not necessarily restricted to the visible spectral range (nevertheless, reference is made to “illumination”, rather than “irradiation”) and can even also encompass corpuscular radiation; illumination with electromagnetic radiation is nevertheless preferred, to be precise preferably with light emitted by a LASER or an LED.

The phosphor element itself is then not necessarily an emission surface mentioned above, rather the generation of light and the lighting arrangement can also be spatially separate from one another and the light of the lighting arrangement can be fed for example with a non-imaging optical unit, for instance a “light guide” or an optical fiber. That can be advantageous with regard to the available space or else for thermal reasons.

With regard to the energy efficiency of the lighting arrangement as well, the luminous flux emitted by an emission surface is preferably reduced by a reduction of the input power of a light source; that is to say that, for example, the pump light input is reduced, to be precise preferably by a corresponding reduction of the input power of the pump light source. A control unit that can be used to set the input power of the light source is preferably part of the lighting arrangement.

In various embodiments, with regard to the rather large-area illumination as well, the lighting arrangement is designed to emit a luminous flux of—with increasing preference in this order—at least 100 lumens, 400 lumens, 2000 lumens, 10 000 lumens, 40 000 lumens; independently thereof, possible upper limits can be for example 400 000 lumens, 300 000 lumens, 200 000 lumens or 100 000 lumens. A dimmability realized by the reduction of the input power of the light source can also be advantageous in this regard, since, for example, with the use of filters, for instance polarization filters, a certain absorption always takes place even in the transmission state, that is to say that the luminous flux is reduced somewhat.

In various embodiments, a diffuser can be provided in a manner disposed downstream of the lighting units in the emission direction. When the lighting arrangement is observed, although the lighting motif can appear somewhat “indistinct” as a result, transitions between closest adjacent lighting units, for example, can thus at least be “smoothed” somewhat.

The arrangement of the emission surfaces on a spherical half-shell has already been described in the introduction in the context of the optical fibers. In order to improve the angular resolution, however, lighting units described generally in the context of this disclosure can also be tilted differently relative to a common plane; in other words, it is possible to provide, for example, a plurality of lighting units on a three-dimensionally extending surface (“spatial surface”) for example on a spherical shell or a tetrahedron.

Therefore, a multiplicity of lighting units are in each case arranged on a spatial surface and a multiplicity of such spatial surfaces are provided, which are particularly preferably arranged such that a common plane intersects them. With further preference, the spatial surfaces, that is to say in particular the spherical shells, can then be provided for example in a hexagonal arrangement with respect to one another.

Besides the lighting arrangement and the corresponding production method, various embodiments, as also already mentioned in the introduction, also relate to the use of such a lighting arrangement for mounting as a ceiling. The lighting arrangement can also be provided in an external region, for example, and, in a manner spanning the latter partly in any case, form a type of roofing; mounting in a stadium is also possible, for example. Generally, the lighting arrangement is preferably mounted on or in a structure, particularly preferably within a building, that is to say in particular in an interior.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1A shows the determination of the luminance of a lighting motif in the case of a first lighting arrangement;

FIG. 1B shows the reproduction of the lighting motif in accordance with figure la with the first lighting arrangement;

FIG. 1C shows the imaging of different directions into different spatial regions;

FIG. 2A shows the direction-dependent luminous flux distribution of a surface element of the lighting motif in accordance with FIGS. 1A and 1B;

FIG. 2B shows, in joint consideration with FIG. 2A, lighting arrangements which are mounted at different heights and reproduce the same lighting motif, in schematic illustration;

FIG. 3 shows the influence of a surface on the light reflection;

FIG. 4A shows light emitting surfaces which are combined with an imaging optical unit to form a lighting unit;

FIG. 4B shows the arrangement in accordance with FIG. 4A supplemented by a microlens array;

FIG. 5 shows optical fiber outputs of an optical fiber array as light emitting surfaces of a lighting unit;

FIG. 6 shows an alternative possibility for generating and coupling light into an optical fiber array in accordance with FIG. 5; and

FIGS. 7A and 7B show different possibilities for luminance measurement.

### DETAILED DESCRIPTION

The following detailed description refers to the accompanying drawings that show, by way of illustration, specific details and aspects of this disclosure in which the invention may be practiced.

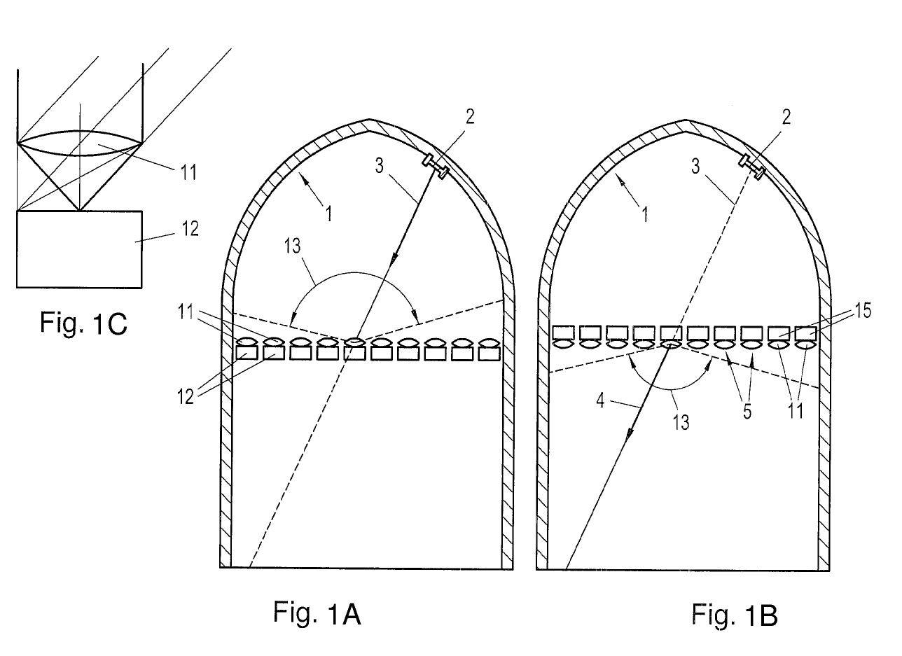

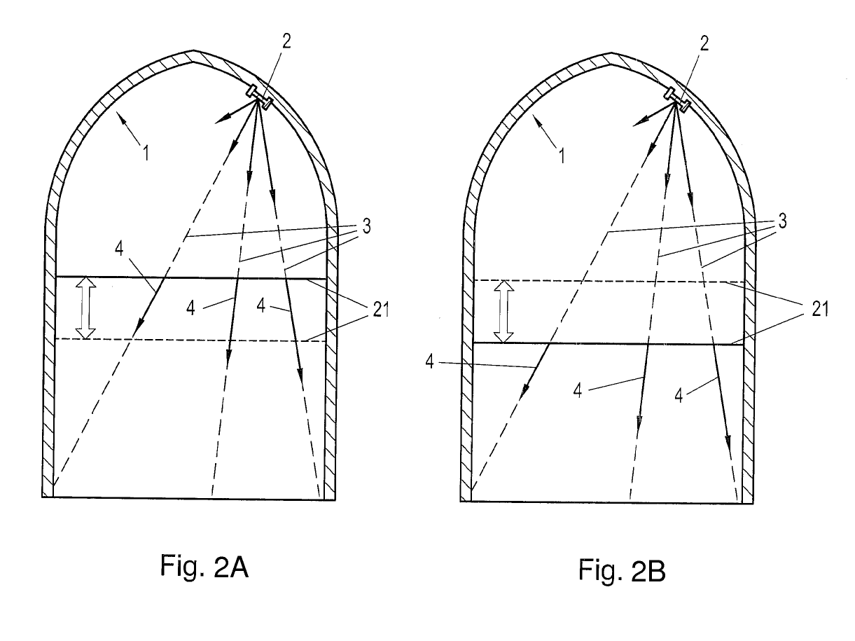

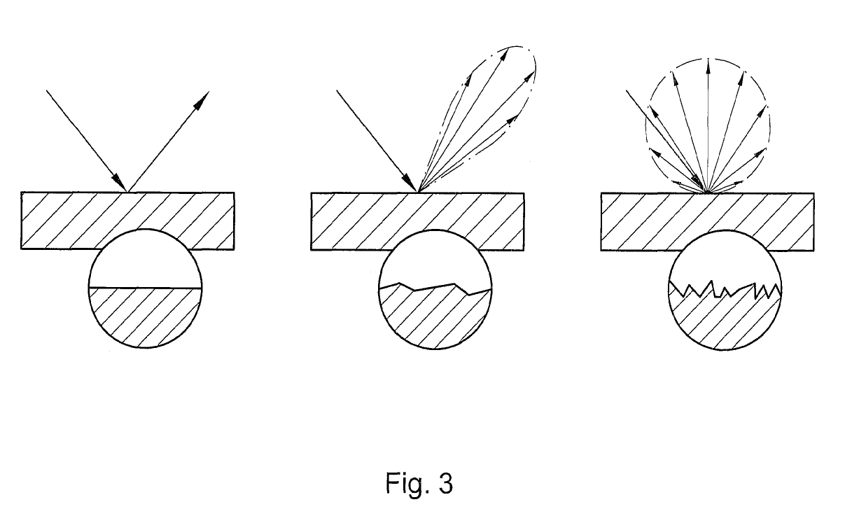

FIG. 1A illustrates the detection of a lighting motif 1, namely of a dome, said detection preceding the reproduction. The dome is illuminated indirectly by a light source (not shown here), such that the individual surface elements 2 reflect light, to be precise different amounts of light direction-dependently along different straight lines 3 (see FIGS. 2A and 2B). The lighting arrangement according to various embodiments is then intended to emit (after the detection of the lighting motif) with the different beams 4 in each case as much light as is emitted by the lighting motif 1 in each case along a straight line 3 on which the respective beam 4 lies, cf. FIG. 1B.

A special feature of the lighting arrangement in accordance with FIGS. 1A and 1B is that concomitantly in parts of the same device firstly a directionally resolved image of the lighting motif 1 is recorded and this image is then reproduced in a directionally resolved manner. Both during the directionally resolved recording and during the directionally resolved reproduction, the transformation from solid angle function to spatial function (recording) and respectively from spatial function to solid angle function (reproduction), is carried out by a full-format fisheye optical unit 11, the diameter of which is greater than the format of a CCD image sensor 12 assigned during recording (FIG. 1A) and respectively of a liquid crystal screen 15 assigned during reproduction (FIG. 1B).

During the recording of the lighting motif 1, the fisheye optical unit 11 of each lighting unit 5 is arranged where it is also intended to be arranged, later, after mounting of the lighting arrangement. In other words, the fisheye optical unit of a lighting unit 5, during the recording of the lighting motif 1, is provided—regarding the distance from the floor, the horizontal position and also the orientation relative to the lighting motif 1—exactly where and how it will also be arranged during the reproduction of the lighting motif 1.

The fisheye optical unit 11 has an aperture angle 13 such that substantially the entire lighting motif 1 is imaged onto the CCD image sensor 12. In this case, light incident on the fisheye optical unit 11 of a lighting unit 5 from different surface elements 2 from different directions (along different straight lines 3) is imaged into different area regions of the CCD image sensor 12 assigned to the fisheye optical unit 11 during recording.

The function of the directions is Fourier-transformed by the fisheye optical unit 11, that is to say becomes a spatial function; the light incident from different directions (along different straight lines 3) with different luminous fluxes passes into different regions of the CCD image sensor 12, that is to say is read out in each case as a value assigned to a specific line and column. FIG. 1C illustrates the imaging of different solid angles into different spatial regions of the CCD image sensor 12; the imaging optical unit (fisheye optical unit 11) transforms a function of the solid angles into a spatial function.

For each lighting unit 5, information is thus available to the effect of from what direction how much light is incident on the fisheye optical unit 11, to be precise as a spatially resolved column/line signal of the CCD image sensor 12. The CCD image sensor 12 has a grid dimension corresponding to its line and column widths; a measured luminous flux value is present per grid point.

For each fisheye optical unit 11, that is to say for each lighting unit 5, the luminous flux values measured by the CCD image sensor 12 are stored as a two-dimensional data field in order then to be reproduced in a next step by the liquid crystal screen 15 with LED backlighting.

The liquid crystal screen 15 has a resolution corresponding to the grid dimension of the CCD image sensor 12, that is to say has exactly the same number of pixels as the CCD image sensor. The pixels of CCD image sensor 12 and liquid crystal screen 15 are also arranged identically, that is to say occupy the same area and are subdivided according to the same number of lines and columns.

The luminous flux distribution measured by a CCD image sensor for each fisheye optical unit 11 in the first step (recording) is then reproduced by a liquid crystal screen 15 assigned to the respective fisheye optical unit 11. The CCD image sensor 12 is therefore replaced by the liquid crystal screen 15, and the latter emits light with exactly the spatial distribution measured by the CCD image sensor. The fisheye optical unit 11 once again brings about a Fourier transformation, to be precise from the space domain (pixels of the liquid crystal screen) into the solid angles (emission directions of the beams 4).

The fisheye optical unit 11 is constructed symmetrically and the liquid crystal screen 15 is arranged in a mirrored fashion with respect to the CCD image sensor 12, to be precise mirrored at a plane which is perpendicular to the optical axis of the fisheye optical unit 11 and runs centrally through the fisheye optical unit 11, that is to say in a manner “turned” upward (otherwise the lighting motif 1 would be reproduced upward, rather than toward the floor). The distance between the fisheye optical unit 11 and the floor and the lighting motif 1 and also the orientation of the optical axis thereof remain unchanged in this case.

Therefore, the liquid crystal screen 15 of each lighting unit 5 then emits light having the different luminous fluxes at the individual pixels, to be precise in different emission directions on account of the fisheye optical unit 11. The light emitted by the lighting unit 5 along a beam 4 then corresponds to the light emitted from a surface element 2 of the lighting motif 1 along a straight line 3 on which the respective beam 4 lies; the lighting unit 5 emits along the beams 4 (in the emission directions) light such as was incident from the different directions (along the straight lines 3).

An observer looking at a lighting arrangement composed of a multiplicity of lighting units 5 therefore sees, in different viewing directions, that is to say in a directionally resolved manner, light such as was emitted by the lighting motif 1 during recording.

During recording, a dedicated CCD image sensor need not, of course, be provided for each lighting unit 5; rather, even with only one CCD image sensor at the different measurement positions, that is to say where a lighting unit 5 will then be arranged in each case, it is possible to carry out measurement and to store the respective luminous flux values position-dependently. During measurement, then either a fisheye optical unit 11 assigned to the CCD image sensor 12 and structurally identical to those of the lighting units 5 is positioned exactly where the fisheye optical unit 11 of the respective lighting unit will be arranged later, or the fisheye optical units 11 of the lighting units 5 are preinstalled and measurement is already carried out using them, that is to say that the (one) CCD image sensor 12 is placed successively onto the individual fisheye optical units 11.

For the production of the lighting arrangement, a dedicated liquid crystal screen 15 is then provided for each lighting unit 5 and reproduces the luminous flux values stored for the respective measurement position (the luminous flux can also be measured in a wavelength-resolved manner and the reproduction can accordingly be carried out in color).

FIGS. 2A and 2B illustrate the luminance on the basis of the example of a surface element 2 of the lighting motif 1 which emits a different luminous flux in different directions (along different straight lines 3). The luminous flux correlates in each case with the length of the arrow depicted per straight line 3, such that more light is thus emitted toward the bottom right than toward the left. An observer sees more light if he/she looks at the surface element 2 from the bottom right than from the bottom left; the surface element 2 is brighter as seen from the bottom right than from the bottom left.

The luminance distribution of the lighting motif 1, that is to say the light emitted from a multiplicity of infinitesimally small surface elements 2 direction-dependently in each case, is determined for example by the arrangement of the lighting motif 1 relative to a light source and by the surface profile (for example a curvature) of the lighting motif 1, that is to say in the present case by the dome shape, inter alia.

The direction dependence of the luminous flux furthermore for example also depends on the optical properties of the surface element 2, that is to say for example on whether the latter is ideally reflective or ideally diffuse.

FIG. 3 illustrates this schematically for three differently reflective surfaces, namely a smooth/ideally reflective surface (left), a rough/ideally diffuse surface (right) and a by comparison less rough/lustrous surface (middle). The incident light beam has the same luminous flux in each case, but only in the case of the smooth, ideally reflective surface is said light beam also reflected in exactly one direction with an identical luminous flux (angle of incidence=angle of reflection).

By contrast, the incident beam is reflected in a Lambertian manner from the rough, ideally diffusely reflective surface (right); the emitted, fanned-out light cone is therefore independent of an angle of incidence of the beam. The lustrous surface in the middle constitutes a mixed form; although the incident beam is fanned out somewhat, it is nevertheless reflected in a main direction whose angle of reflection corresponds to the angle of incidence.

Therefore, in any case, different amounts of light are emitted from the surface elements 2 direction-dependently and this is also a consequence of the three-dimensionality, either indirectly (owing to the light incidence on a reflective surface) or directly (on account of the three-dimensionality of the lighting motif 1 itself, that is to say for instance on account of the curvature of the dome).

The light emitted from the surface elements 2 of the lighting motif 1 direction-dependently, that is to say the luminance distribution of the lighting motif 1, is crucial for the three-dimensional impression that an observer has thereof; if the lighting units 5 then emit in the emission directions of the beams 4 in each case as much light as would be emitted (was emitted during recording) by the lighting motif 1 in the respective direction, an observer ideally cannot distinguish whether the light comes from the lighting arrangement or the lighting motif 1.

Nevertheless, in practice a totally realistic reproduction of the lighting motif 1 often does not become possible or desirable, also on account of the conflict of aims between spatial resolution and solid angle resolution; an observer can therefore perceive the lighting motif for example also as through a slightly cloudy sheet; this can be deliberately set by the use of a diffuser.

In the case of the lighting arrangement explained with reference to FIGS. 1A and 1B, the mounting location of the lighting units 5 is predefined by the recording location (or conversely: the direction-dependent light distribution is measured where mounting is intended to be carried out).

In general, however, the mounting location can be chosen freely; the (later) mounting location then predefines a reference surface 21 for which the luminous flux is to be determined which has to be emitted by an emission point as a beam 4 in an emission direction in order that the direction-dependent light distribution generated by the lighting arrangement corresponds to the direction-dependent light distribution emitted from the lighting motif 1.

To put it in a simplified way, a light beam emitted from a surface element 2 along a specific straight line 3 is shifted along this straight line 3 with its starting point onto the reference surface; an observer is then given the impression that the light came from the lighting motif 1 if, at a location of the lighting arrangement corresponding to the position of the starting point in the reference surface 21, an emission surface emits light of the same intensity along the same straight line 3 (the beam 4 of the emission surface lies on the straight line 3).

If the reference surface 21 is shifted downward, for example, that is to say if the lighting arrangement is mounted at a lower height, the starting point of a light beam in this case shifts not only vertically but also horizontally (cf. FIG. 2B). The luminous flux emitted as beam 4 along a respective straight line 3 remains the same; however, the corresponding beam 4 is emitted by a different emission surface of the lighting arrangement. If the vertical offset is large, the corresponding emission surface will usually be assigned to a different lighting unit 5.

For reasons of practicability, too, in this case, after selection of the reference surface 21, that is to say the mounting location, the emission surface is usually not shifted such that it coincides with the starting point of a light beam determined previously, rather, with knowledge of a horizontal position of the emission surface (the vertical position is predefined by the selection of the reference surface 21) the light beam “appropriate” for that is determined. Therefore, at a specific location, an emission surface with a specific emission direction is provided and then the luminous flux to be emitted by the emission surface in this emission direction is determined, to be precise by rendering.

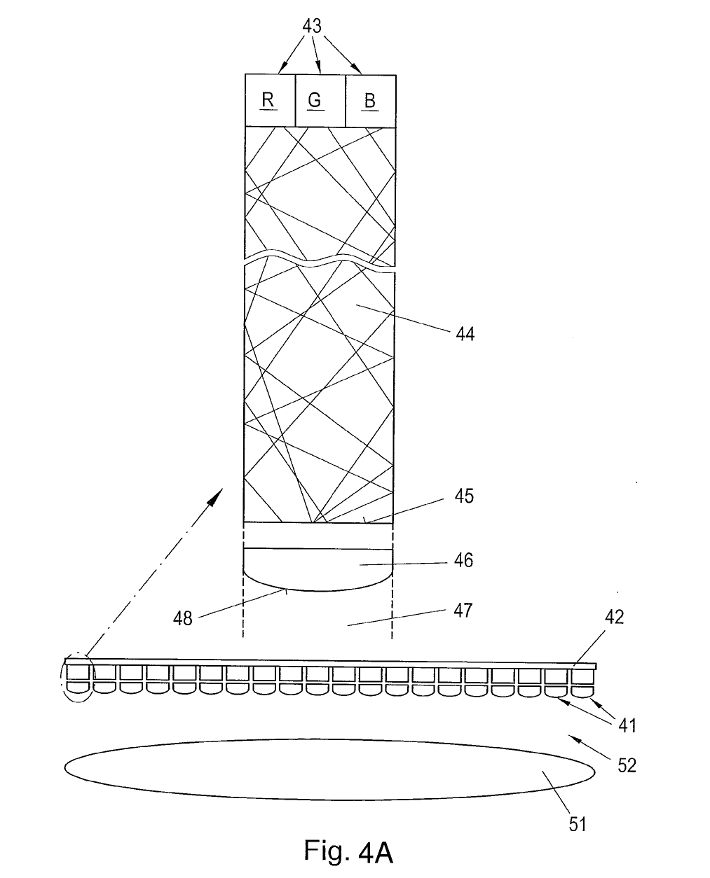

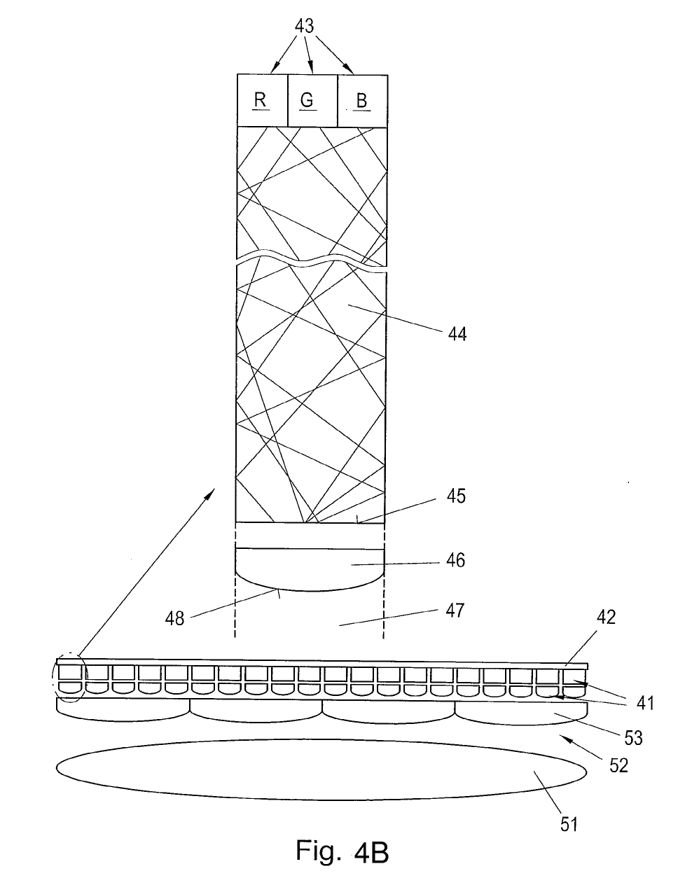

FIGS. 4A and 4B show a lighting unit 5 having a multiplicity of light sources 41 mounted on a common substrate 42; the latter also serves for cooling the light sources 41.

A light source 41 illustrated in an enlarged view in each case in FIGS. 4A and 4B is composed of three LEDs 43, namely one red (R), one green (G) and one blue (B) LED 43. The three LEDs of a light source 41 are arranged adjacent to one another and with their light emitting surfaces they adjoin a non-imaging optical unit 44, namely a “light guide”.

The non-imaging optical unit 44 serves for mixing the red, green and blue light; at an exit surface 45 thereof, uniformly intermixed light emerges, for instance white light, provided that all three LEDs 43 are operated.

An imaging primary optical unit 46 shapes the light emerging from the non-imaging optical unit 44 to form a beam 47; the light emitting surface 48 of the light source 41 is situated on the exit side of the imaging optical unit 46.

The light emitting surfaces 48 of the light sources 41 are arranged alongside one another and are imaged into infinity by a common imaging optical unit 51, in the spatial directions of different beams 4.

The spatial function predefined by the arrangement of the light sources 41 alongside one another is Fourier-transformed by this imaging, that is to say becomes a function of the solid angles (emission directions). The spatial resolution, that is to say the size of the light emitting surfaces 48 and their distance between one another, determines, besides the imaging properties of the imaging optical unit 51, the solid angle resolution, that is to say the “fan-out” of the emission directions (of the beams 4).

In the case of the embodiment shown in FIG. 4B, a microlens array 52 is placed between the light emitting surfaces 48 of the light sources 41 and the imaging optical unit 51; a set of light sources 41 (a subset of the light sources) is respectively assigned to a microlens 53. The lighting unit 5 is subdivided again by the microlenses; the microlens array 52 thus improves the spatial resolution, specifically at the expense of the solid angle resolution.

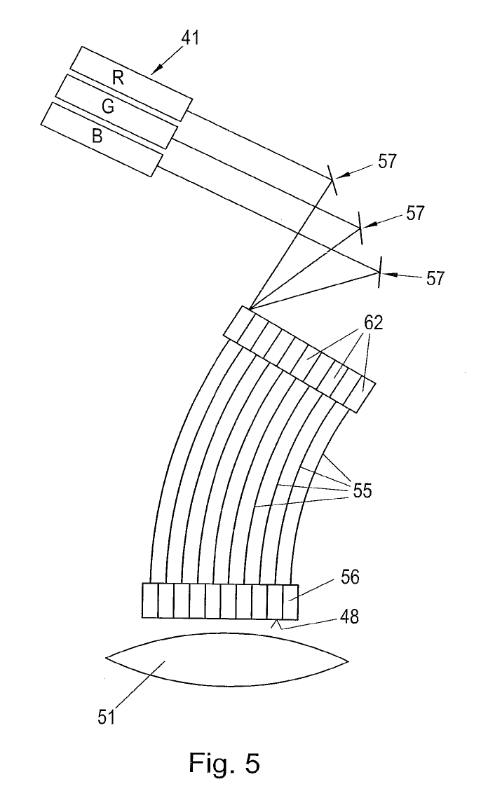

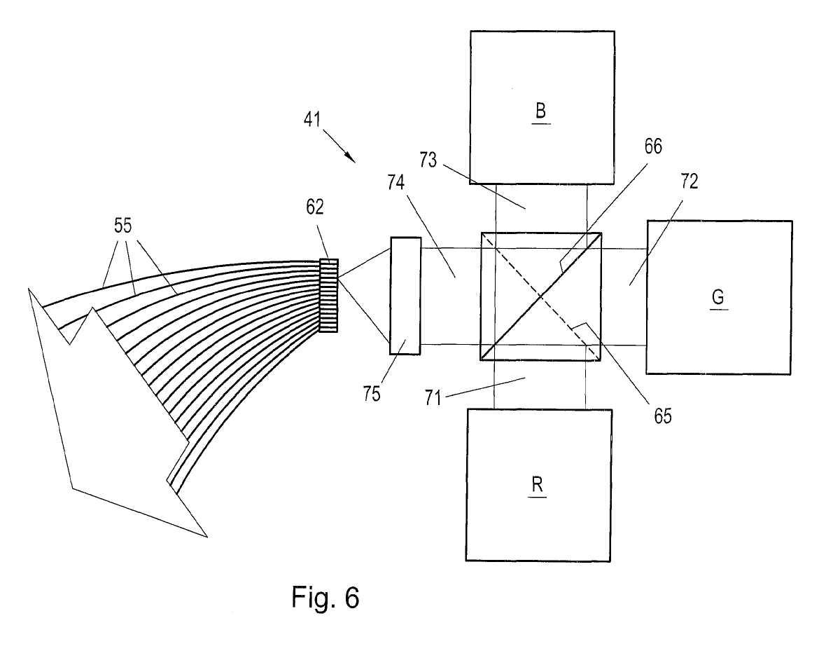

FIGS. 5 and 6 show alternative light sources 41 and an alternative light feeding with respect to FIGS. 4A and 4B. In both embodiments in accordance with FIGS. 5 and 6, the light generated spatially separately by the imaging optical unit 51 is guided via optical fibers 55 to the imaging optical unit 51.

At the end side of each optical fiber 55, an output coupling element 56 is provided, in this case a non-imaging optical unit having an extended cross section relative to the optical fiber 55 (FIG. 5). On account of the extension of the cross section, the light is concentrated (conservation of etendue), and the light emerges as an almost parallel beam at an exit surface 48 of the output coupling element 56. The imaging optical unit 51 then in turn images the exit surfaces 48 arranged alongside one another in a planar manner (spatial resolution) in different emission directions (solid angle resolution). FIG. 5 shows generation of light and also light input and light output coupling; by contrast, FIG. 6 shows an alternative generation of light and the input coupling (the output coupling not being shown, for the sake of clarity).

The light source 41 in accordance with FIG. 5 includes three LASER light sources of the colors red, green and blue (RGB); each LASER light source is assigned a tiltable mirror 57 (“scanning mirror”), via which the respective LASER beam can be directed in the direction of the input coupling elements 62 of the optical fibers 55.

The mirrors 57 are in each case tiltable in two axes, such that the respective LASER beam, in a manner dependent on the tilting angles of the respective mirror 57, can be directed in a targeted manner onto in each case one of the input coupling elements 62 (the input coupling elements 62 are arranged alongside one another in a planar manner, that is to say also extend perpendicularly to the plane of the drawing; this planar arrangement is accessible by the tilting of the mirrors 57 about two axes in each case).

In this way, by corresponding adjustment of the mirrors 57, the individual input coupling elements 62 are sequentially illuminated with the three LASER beams, wherein the respective RGB composition determines the color of the light coupled into the respective input coupling element 62. Ideally, a luminous flux corresponding to the colors of the image to be established is emitted by the LASER light sources 41, which is advantageous for reasons of energy efficiency compared with (variable) filtering of a constant luminous flux.

FIG. 6 shows alternative generation of light with respect to FIG. 5; the light generated by the light source 41 is in turn coupled into input coupling elements 62 of the optical fibers 55. Before the input coupling, the red, green and blue light generated separately from one another is mixed in a “light cube”, which for this purpose is constructed from two dichroic mirrors 65, 66.

The first dichroic mirror 65 is reflective for red light and transmissive for blue and green light. The red light 71 emitted by the red light source (explained in greater detail below) is therefore reflected by the first dichroic mirror 65, to be precise in the direction of an imaging image unit 75, explained in detail below.

By contrast, the first dichroic mirror 65 is transmissive for the green light 72, and so is the second dichroic mirror 66. The green light 72 passes through the “light cube” therefore substantially without absorption/reflection in the direction of the image unit 75.

The second dichroic mirror 66 is reflective only for the blue light 73; the latter is reflected toward the converging lens 61. Consequently, mixed light 74 is present downstream of the “light cube” and is coupled into the optical fibers.

The generation of the red, green and blue light 71, 72 and 73 is carried out in each case by pump light illumination of a red, green and respectively blue phosphor element (not shown in detail here); the phosphor element is illuminated with short-wave blue pump light or ultraviolet pump light and then emits conversion light of the corresponding color (red, green, blue). The conversion light can be “collected” by the phosphor element for example in a “light guide”, for example a “compound parabolic concentrator”, and passed to the “light cube”.

By a variation of the pump light illumination, that is to say a control of the pump light source, the luminous flux of the conversion light can be altered; therefore, the hue of the mixed light 74 can also be altered by a separate control of the R, G and/or B proportion. Furthermore, the brightness can thus also be adapted.

The imaging image unit 75 directs the mixed light 74 respectively generated with a specific color at a point in time onto the input coupling elements 62 arranged in a planar manner; as a result of the coupling of the mixed light 74 respectively adapted in terms of hue and brightness into the input coupling elements 62, a planar image is generated (and converted into solid angles by the imaging optical unit assigned to the output coupling elements 56).

The image unit 75 shown schematically in FIG. 6 can consist for example of a so-called micromirror array (“digital micromirror device”, DMD array) with downstream converging lens; in this case, the pump light sources could also be operated with constant power and, depending on the position of the micromirror assigned to a respective input coupling element 62, the input coupling element 62 would or would not be supplied with light (moreover, a “light cube” described above would not need to be provided, rather the RGB mixing could also be carried out on average over time, by a corresponding position of the micromirrors).

As an alternative to a micromirror array, a so-called LCOS display (“liquid crystal on silicon”) could also be provided for example as the imaging unit. In this case, the light is directed via a polarizing mirror onto a display including liquid crystals; the reflection of the light by the display can then be set in the individual pixels by an electrically controlled alignment of the liquid crystals.

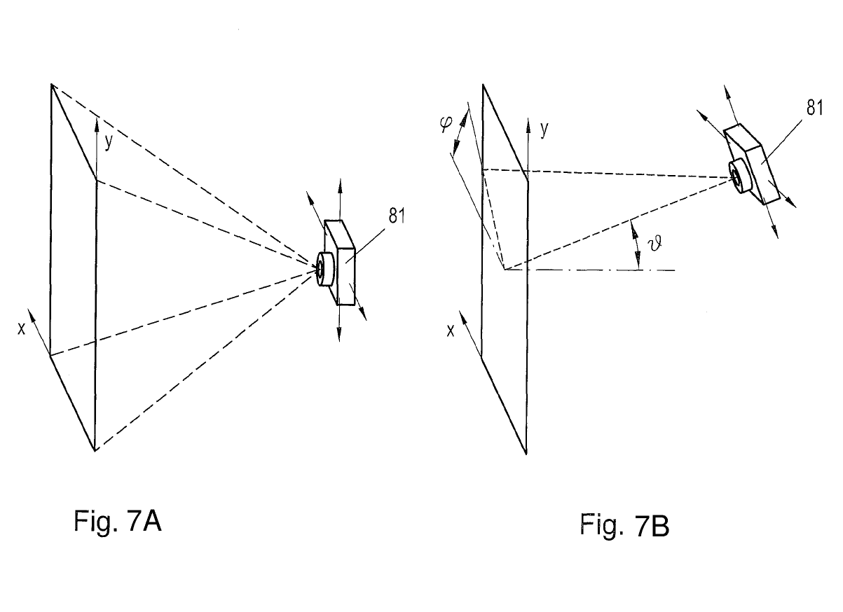

FIGS. 7A and 7B illustrate a luminance measurement for detecting a real lighting motif 1. A camera 81 is used to make a multiplicity of recordings of a reference surface which is spaced apart from the lighting motif and at least partly surrounds the latter. By the imaging optical unit of the camera 81, the beams arriving at a respective measurement position from different directions (along different straight lines 3) are imaged into different regions of a sensor of the camera 81. With knowledge of the imaging properties of the camera 81, the solid angle resolution can then be determined from the measured spatial resolution.

Such recordings are made for a multiplicity of measurement positions, for which purpose the camera 81 can be moved for example in a manner following a grid lying in a plane (FIG. 7A) or else along a curved area and for this purpose can be mounted for example in a goniometer (FIG. 7B). With knowledge of the measurement positions, the images thus generated can be combined and thus yield a luminance image of the lighting motif 1, that is to say contain information to the effect of how much light is emitted from which surface element of the lighting motif in which directions (along which straight lines 3).

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A method for producing a lighting arrangement for reproducing spatial views of a lighting motif, the method comprising:
providing a three-dimensional lighting motif;
choosing a reference surface;
for a multiplicity of points on the reference surface and a multiplicity of surface elements of the lighting motif determining the luminous flux emitted in each case along a straight line, connecting the respective reference surface point and the respective surface element, from the surface element;
providing a lighting arrangement designed to emit light at a multiplicity of emission surfaces in each case along a beam, wherein the beams of different emission surfaces are tilted with respect to one another; and
setting up the lighting arrangement in such a way that a reference surface point in each case coincides with an emission surface and the light emitted by the respective emission surface is emitted as a beam lying on the straight line of the respective reference surface point, wherein the emission surface emits a luminous flux corresponding to the respective reference surface point.

2. The method as claimed in claim 1, wherein raw data are generated by the three-dimensional lighting motif and the luminous flux is determined per reference surface point by the raw data being rendered.

3. The method as claimed in claim 2, wherein an arrangement of the emission surfaces is defined and the rendering is carried out relative to this predefined arrangement.

4. The method as claimed in claim 1, wherein the lighting motiff is a real arrangement and raw data thereof for determining the luminous flux per reference surface point are obtained by a luminance measurement.

5. The method as claimed in claim 1, wherein a motif reproduced with the lighting arrangement has a size ratio of at least 1:4 with respect to the lighting motiff.

6. The method as claimed in claim 1, wherein the reproduced lighting motif is motionless in an area proportion of at least 50%.

7. The method as claimed in claim 1, wherein the reproduction is altered in a manner coordinated with an observer.

8. The method as claimed in claim 1, wherein the relative profile of the reproduced spectrum at least in the visible spectral range corresponds to the solar spectrum.

9. A lighting arrangement for reproducing spatial views of a lighting motif,
which is designed for operation in such a way that light is emitted at a multiplicity of emission surfaces,
wherein the luminous flux emitted as a beam at an emission surface corresponds to the luminous flux emitted from the lighting motif along a straight line which connects the emission surface and the lighting motif and on which the beam lies,
such that spatial views of the lighting motif is reproduced with the lighting arrangement.

10. The lighting arrangement as claimed in claim 9, which is designed to reproduce the stereoscopic views relative to a first observation line and relative to a second observation line, which extends transversely with respect to the first observation line.

11. The lighting arrangement as claimed in claim 9, wherein the lighting arrangement comprises an imaging optical unit which images a light emitting surface of a light source into space.

12. The lighting arrangement as claimed in claim 11, wherein a plurality of light emitting surfaces are arranged alongside one another in a manner combined to form a lighting unit and are imaged by a common imaging optical unit along different beams.

13. The lighting arrangement as claimed in claim 12, wherein the imaging optical unit of a lighting unit has a microlens array.

14. The lighting arrangement as claimed in claim 9, wherein a lighting unit has a lateral extent of at most 10 cm and at least 0.25 cm.

15. The lighting arrangement as claimed in claim 9, wherein a light source of a lighting unit has a phosphor element designed for emitting converted light on account of an excitation with pump light emitted by a pump light source, wherein the converted light is fed to the further use by a light guide.

16. The lighting arrangement as claimed in claim 9, the brightness of which is dimmable down to a switched-off state.

17. The lighting arrangement as claimed in claim 9, which is designed for emitting a luminous flux of at least 100 lumens.

18. The lighting arrangement as claimed in claim 9, comprising a diffuser disposed downstream of the emission surfaces in the emission direction.

19. The lighting arrangement as claimed in claim 9, which is subdivided into a multiplicity of lighting units which are arranged in a tilted fashion in relation to a common surface for the purpose of extending the solid angle range accessible to the lighting.

20. The lighting arrangement as claimed in claim 9, wherein the lighting arrangement is used for mounting as a ceiling.
